(19) United States
(12) Patent Application Publication
(10) Pub. No.: US 2026/0025469 A1
(43) Pub. Date: Jan. 22, 2026

(54) INFORMATION PROCESSING APPARATUS, CONTROL METHOD FOR INFORMATION PROCESSING APPARATUS, AND COMPUTER-READABLE STORAGE MEDIUM STORING PROGRAM

(71) Applicant: CANON KABUSHIKI KAISHA, Tokyo (JP)

(72) Inventor: Ayuko ISHII, Kanagawa (JP)

(21) Appl. No.: 19/270,533

(22) Filed: Jul. 16, 2025

(30) Foreign Application Priority Data
Jul. 22, 2024 (JP) 2024-117236

(51) Int. Cl. H04N 1/00; G06F 40/174

(52) U.S. Cl. CPC H04N 1/0001; G06F 40/174

(57) ABSTRACT

An information processing apparatus, including: an obtaining unit configured to obtain response data for an assignment to be scored; a processing unit configured to perform processing to analyze a response completion degree in the response data obtained by the obtaining unit, without regard to a criterion for scoring; and a control unit configured to perform control to: in a case where a result of the analysis satisfies a predetermined condition, transmit the response data to a first transmission destination corresponding to an assignment submission destination based on a first operation for submitting the assignment; and in a case where the result of the analysis does not satisfy the predetermined condition, not transmit the response data to the first transmission destination based on the first operation.

### BACKGROUND

### Field of the Technology

The present disclosure relates to an information processing apparatus, a control method for an information processing apparatus, and a computer-readable storage medium storing a program.

### Description of the Related Art

In order to have a learner learn the learning content in daily learning, learning assignments such as homework may be given to learner. In such a case, it is important for the learner to seriously engage with the learning assignment. Technologies for managing the learning status of the learner have been proposed. For example, Japanese Patent Laid-Open No. 2020-115175 discloses a technology for estimating the learning status of a learner.

### SUMMARY

The present disclosure provides a technology that contributes to a learner's more serious engagement in responding to an assignment.

The present disclosure in one aspect provides an information processing apparatus, comprising at least one memory and at least one processor which function as: an obtaining unit configured to obtain response data for an assignment to be scored; a processing unit configured to perform processing to analyze a response completion degree in the response data obtained by the obtaining unit, without regard to a criterion for scoring; and a control unit configured to perform control to: in a case where a result of the analysis satisfies a predetermined condition, transmit the response data to a first transmission destination corresponding to an assignment submission destination based on a first operation for submitting the assignment; and in a case where the result of the analysis does not satisfy the predetermined condition, not transmit the response data to the first transmission destination based on the first operation.

According to the present disclosure, it is possible to provide a technology that contributes to a learner's more serious engagement in responding to an assignment.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 shows an example of a system configuration.

FIG. 2 shows an example of a configuration of an information processing apparatus.

FIG. 3 is a flowchart illustrating assignment submission processing.

FIG. 4 is a flowchart illustrating completion degree analysis processing.

FIGS. 5A to 5D illustrate categories of response data.

FIGS. 6A to 6J show display examples of a display unit.

FIGS. 7A to 7D show display examples of the display unit.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The conventional technology is unable to have a learner seriously engage in an assignment and submit the assignment. Thus, there is a need for a technology for having a learner seriously engage in an assignment and submit the assignment.

According to one aspect of the present disclosure, it is possible to provide a technology that contributes to a learner's more serious engagement in responding to an assignment.

### First Embodiment

### System Configuration

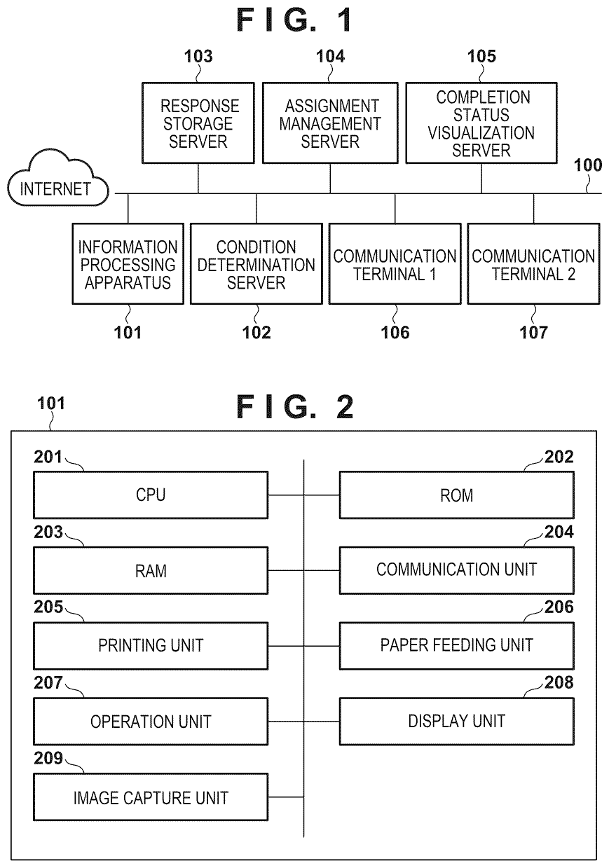

FIG. 1 shows an example of a configuration of an education system according to the present embodiment. As an example, the system includes an information processing apparatus 101, a condition determination server 102, a response storage server 103, an assignment management server 104, a completion status visualization server 105, a communication terminal 106, a communication terminal 107, and so on. These devices are connected to the Internet via a communication line 100 and can communicate with each other.

The information processing apparatus 101 corresponds to an end point on the learner side, and corresponds to an input device for inputting a response to an assignment to be submitted by the learner. In the present embodiment, a printing apparatus having a scanning function, a printing function, and the like is described as an example of the information processing apparatus 101. The information processing apparatus 101 may alternatively be, for example, an image reading apparatus having a scanning function.

The condition determination server 102 is a server for analyzing data obtained by the information processing apparatus 101 and analyzing a completion degree. The condition determination server 102 converts the completion degree into percentages, points, or the like in completion degree analysis processing, which will be described later. The response storage server 103 is a server for storing response data corresponding to each assignment. The assignment management server 104 is a server for managing settings of each assignment to be submitted, the submission status of the assignment, response data, and the like. The completion status visualization server 105 is a server for managing the assignment completion status.

The communication terminal 106 corresponds to, for example, an end point on the learner's guardian side. The communication terminal 106 can obtain the completion status of the learner's assignment by, for example, accessing the completion status visualization server 105.

The communication terminal 107 corresponds to, for example, an end point on the instructor side. The instructor is, for example, a teacher at a school or a cram school to which the learner belongs, and can set an assignment to be submitted to the assignment management server 104 by using the communication terminal 107. Note that each of the communication terminals 106 and 107 may be, for example, a smartphone, a tablet terminal, a PC, or the like.

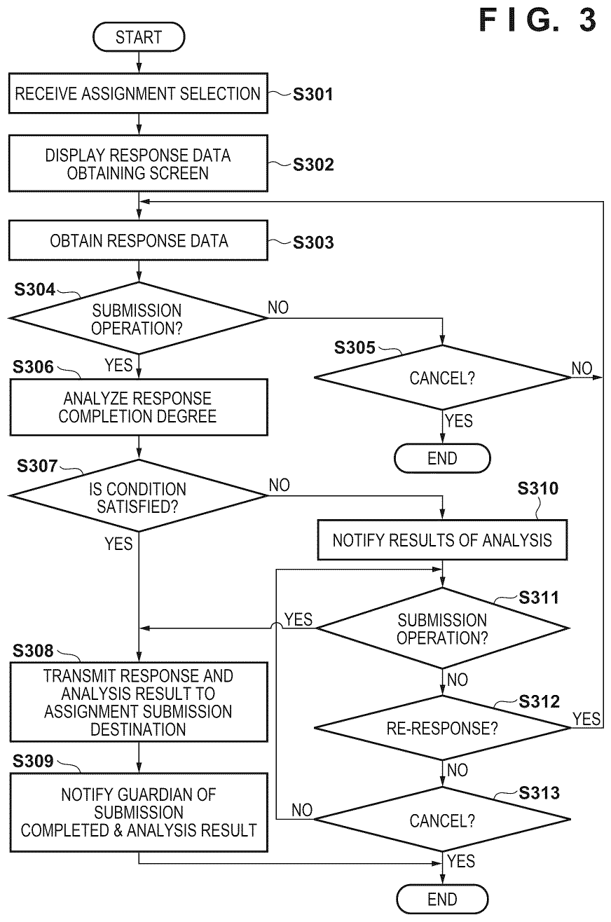

FIG. 2 shows an example of a hardware configuration of the information processing apparatus 101 according to the present embodiment. The information processing apparatus 101 includes a CPU (central processing unit) 201, a ROM 202, a RAM 203, a communication unit 204, a printing unit 205, a paper feeding unit 206, an operation unit 207, a display unit 208, and an image capture unit 209.

The CPU 201 is a system control unit including at least one processor, and performs overall control of the information processing apparatus 101. In one example, the following processing of the information processing apparatus 101 is implemented by the CPU 201 executing programs stored in the ROM 202. Note that hardware dedicated to each type of processing may be prepared.

The ROM 202 stores control programs executed by the CPU 201, an embedded OS program, and so on. In the present embodiment, the CPU 201 performs software control such as scheduling and task switches by executing the control programs stored in the ROM 202 under the management of an embedded OS that is also stored in the ROM 202.

The RAM 203 is constituted by an SRAM or the like. The RAM 203 stores data such as program control variables, and data such as setting values registered by a user and management data of the information processing apparatus 101. The RAM 203 may also be used as a buffer for various work.

The communication unit 204 communicates data with external devices such as the servers 102 to 105 and the communication terminals 106 and 107. The communication unit 204 includes, for example, a wireless LAN module. The wireless LAN module is a communication module for transmitting and receiving data to and from external devices on the communication line 100 via a wireless LAN, such as Wi-Fi (registered trademark). Note that the communication unit 204 may also include other communication modules, such as a USB module for transmitting and receiving data to and from other external devices via a USB cable. Further, the communication unit 204 may also include a communication module that is different in coverage from the wireless LAN module, such as a module for short-range wireless communication including Bluetooth (registered trademark).

The printing unit 205 records image data read by the image capture unit 209, image data received from an external device, or the like by discharging a recording material such as ink to recording paper set in the paper feeding unit 206. Further, the information processing apparatus 101 includes, for example, a print control unit or the like. The print control unit performs various types of image processing such as smoothing, printing density correction, and color correction on image data to be printed, and outputs the processed image data to the printing unit 205.

The paper feeding unit 206 holds paper for printing. The paper feeding unit 206 can supply set paper under the control of the print control unit. The paper feeding unit 206 may include a plurality of paper feeding units to hold a plurality of types of paper in one device, and can control which paper feeding unit 206 will feed paper under the control by the print control unit.

The operation unit 207 includes, for example, a button, a switch, and a touch panel, and detects an operation of the information processing apparatus 101 performed by the user. The user can input various commands to the information processing apparatus 101 using various operation interfaces provided in the operation unit 207. The display unit 208 displays various types of information to the user. The display unit 208 is, for example, a display having an LCD type display mechanism. Note that the operation unit 207 may be a touch screen integrated with the display unit 208.

The image capture unit 209 captures an image of an original and converts the captured image data into image data. In the present embodiment, the image capture unit 209 is a reading device (scanner) capable of reading an image, optically reads an original image by illuminating an original placed on a document table, and converts the image into an electrical signal to create image data. The image capture unit 209 may include, for example, a CIS (contact image sensor) as an image sensor, or a CCD/CMOS image sensor with an array of pixels.

### Learner's Engagement in Assignment

In the field of education and the like, there are cases where learners are given learning assignments such as homework. Learning assignments are intended, for example, to have the learners master the learning content in daily learning and to allow the instructor to grasp the learners' understanding of the learning content. It is therefore important for the learners to seriously engage in assignments.

Here, for example, assume a low-age learner. In this case, for example, there are cases where the learner has not developed a habit of seriously engaging in assignments. Thus, when the learner engages in an assignment such as homework given by a school or a cram school, their guardian needs to be involved in some cases. However, in recent years, with the increase in dual-earner households, guardians have less time to be involved in learner's (their child's) learning. Also assume that a learner does not seriously engage in an assignment, e.g., not entering responses to the assignment. In such a case, the instructor needs to be involved in the learner's engagement in the assignment, such as asking the learner to resubmit the assignment, which takes time and effort. For this reason, there is a need for a technology for having learners seriously engage in assignments and submit the assignments without bothering people such as their guardians.

In the present embodiment, the information processing apparatus 101 obtains response data for an assignment. The information processing apparatus 101 perform processing to analyze a response completion degree in the obtained response data without regard to whether it is correct or incorrect (without regard to a scoring criteria). If the analysis result satisfies a later-described predetermined condition, the information processing apparatus 101 transmits the response data to a transmission destination corresponding to an assignment submission destination based on an assignment submission operation. Scoring takes place after the response data for the assignment is transmitted to the assignment submission destination. On the other hand, if the analysis result does not satisfy the predetermined condition, the information processing apparatus 101 performs control so as not to transmit the response data to the transmission destination based on the submission operation. That is, control is performed such that the response data that does not satisfy the predetermined condition is not to be scored. Thus, in the present embodiment, the learner cannot submit the assignment if the response data for the assignment does not satisfy the predetermined condition. It is therefore possible to have the learner seriously engage in the assignment and submit the assignment.

### Assignment Submission Processing

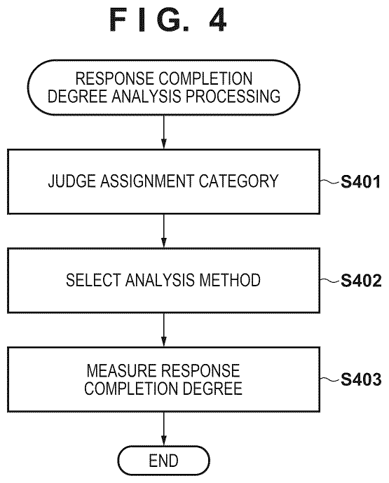

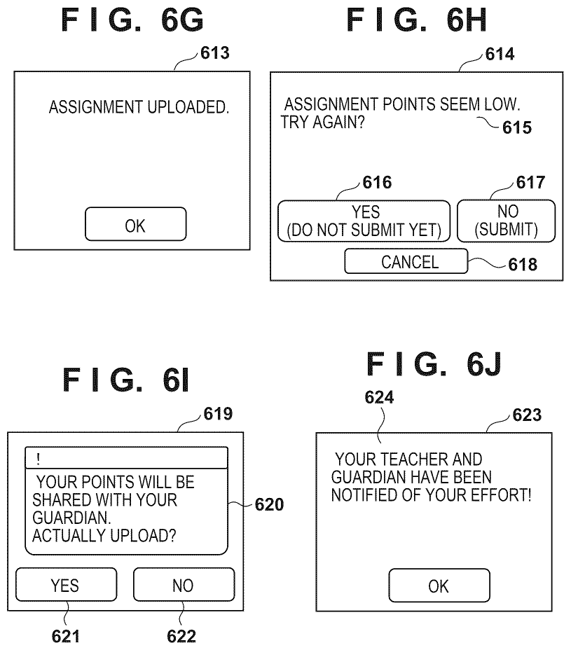

Assignment submission processing performed by the CPU 201 is described below. FIG. 3 is a flowchart illustrating an example of the processing according to the present embodiment. The processing in FIG. 3 is implemented, for example, by the CPU 201 loading a program stored in the ROM 202, which is a computer-readable recording medium, to the RAM 203 and executing it. The processing in FIG. 3 is described below with reference to FIGS. 6A to 6J. FIGS. 6A to 6J show examples of screens displayed on the display unit 208 of the information processing apparatus 101.

The processing in FIG. 3 may be performed, for example, when the CPU 201 receives an operation to start a selection of an assignment. First, when submitting an assignment, the learner operates a function screen. FIG. 6A shows an example of a function screen 601 that the CPU 201 causes the display unit 208 to display. The function screen 601 is a screen that enables receiving a selection of a function available via the information processing apparatus 101. In this example, the function screen 601 displays a display item labeled “School Classroom”, which enables receiving an instruction to execute a function related to learning assignments. Functions related to learning assignments include, for example, a function of obtaining data on a learning assignment assigned to the learner from the instructor, a function of obtaining response data for the assignment, and a function of submitting the learning assignment.

Note that the function screen 601 may be a screen displaying, for example, a list of application programs installed in the information processing apparatus 101. For example, the function screen 601 may display an application program that causes the information processing apparatus 101 to execute a function related to learning assignments. Hereinafter, the application program related to learning assignments is referred to as an assignment application. The information processing apparatus 101 may, for example, obtain the assignment application from an external server via the Internet and store the assignment application in the ROM 202 or the like. Further, the information processing apparatus 101 may have the assignment application stored in advance in the ROM 202. The processing in FIG. 3 may also be implemented by the CPU 201 loading the assignment application stored in the ROM 202, which is a computer-readable recording medium, to the RAM 203 and executing it.

When “School Classroom” is selected by the user, the CPU 201 causes the display unit 208 to display an assignment management screen. FIG. 6B shows an example of an assignment management screen 602. The assignment management screen 602 displays a display item 603 that enables receiving a display instruction to display data on an assignment assigned by the instructor. For example, the CPU 201 starts the processing in step S301 when the display item 603 is pressed. The assignment management screen 602 displays a display item 604 that enables receiving a display instruction to display response data for an assignment that has already submitted by the learner. When the display item 604 is pressed, the CPU 201 obtains the response data for the assignment already submitted by the learner from the response storage server 103. The CPU 201 then causes the display unit 208 to display the response data obtained from the response storage server 103 as submitted data. Further, the assignment management screen 602 displays a display item 605 that enables receiving a display instruction to display a list of assignments that has already been submitted by the learner and scored by the instructor. When the display item 605 is pressed, the CPU 201 obtains a list of assignments scored by the instructor from the assignment management server 104.

Note that the CPU 201 may cause the display unit 208 to display a login screen (not shown) when “School Classroom” is selected by the user. The login screen (not shown) is, for example, a screen for identifying a learner, an administrator, or the like, and is a screen that enables receiving user information such as a user ID and a password. When the learner's user information is input, the CPU 201 causes the display unit 208 to display, for example, the assignment management screen 602.

In step S301, the CPU 201 obtains, for example, assignment data assigned to the learner by the instructor from the assignment management server 104, and causes the assignment data to be displayed on the selection screen. Here, the assignment data displayed on the selection screen is not limited to that assigned by the instructor, and need only be candidates to be responded to (submitted) by the learner who is going to respond to and submit. Then, the CPU 201 receives an instruction to select an assignment to be submitted from the learner. FIG. 6C shows an example of a selection screen 625 that the CPU 201 causes the display unit 208 to display in step S301. The selection screen 625 displays, for example, a list of assignments assigned to the learners by the instructor. Further, the selection screen 625 is a screen that enables receiving an instruction to select an assignment to be submitted from the list.

Upon receiving an instruction to select an assignment to be submitted, the CPU 201 causes a submission operation screen to be displayed. FIG. 6D shows an example of a submission operation screen 606 displayed on the display unit 208 when the CPU 201 receives an instruction to select an assignment to be submitted. The submission operation screen 606 displays an upload button 607 that enables receiving an instruction for the learner to upload response data for the assignment to be submitted, and a print button 608 that enables receiving a print instruction to print the assignment data. Hereinafter, it is assumed that each button displayed is also a type of display item. For example, when the print button 608 is pressed, the CPU 201 causes the printing unit 205 to print the assignment data selected on the selection screen 625. It is assumed in the following description that the assignment data has been printed as a fill-in form in step S301.

In step S302, the CPU 201 causes an image capture screen to be displayed, for example, when the upload button 607 is pressed on the submission operation screen 606. FIG. 6E shows an example of an image capture screen 609 that the CPU 201 causes the display unit 208 to display when the upload button 607 is pressed by the user. The image capture screen 609 displays, for example, a message prompting the user to capture an image of (scan) the fill-in form for responses. The image capture screen 609 also displays, for example, a display item that enables receiving settings (scan settings) such as the size and type of the fill-in form whose image is to be captured. That is, the image capture screen 609 can also be considered as a screen for obtaining response data to be submitted.

In step S303, when the CPU 201 causes the image capture screen 609 to be displayed and receives an instruction to capture an image, the CPU 201 causes the image capture unit 209 to capture and image of the fill-in form. Then, the CPU 201 obtains, as response data, the captured image data of the fill-in form whose image has been captured by the image capture unit 209. In the present embodiment, the image capture unit 209 is a scanner as mentioned above. That is, in step S303, the CPU 201 obtains response data by causing the image capture unit 209 to scan the fill-in form. The instruction to capture an image is received by, for example, a physical button (scan start button that is a physical key) provided in the main body of the information processing apparatus 101. Note that the image capture screen 609 may display a display item that enables receiving the instruction to capture an image.

In step S304, the CPU 201 determines whether or not an operation to submit the response data has been received. If the CPU 201 determines that the submission operation has been received, the processing proceeds to step S306. On the other hand, if the CPU 201 determines that a submission operation has not been received, the processing proceeds to step S305. Specifically, for example, the CPU 201 causes the display unit 208 to display the submission operation screen 606 after the image capture (obtainment of the response data) has ended in step S303. When the upload button 607 is pressed, the CPU 201 causes the display unit 208 to display an upload execution screen. FIG. 6F shows an example of an upload execution screen 610 caused to be displayed by the CPU 201 when the upload button 607 is pressed by the user. The upload execution screen 610 is a screen for receiving a submission operation. The upload execution screen 610 displays a button 611 that enables receiving a submission instruction to submit response data, and a button 612 that enables receiving a non-submission instruction not to submit response data. In step S303, if the button 611 is pressed, the CPU 201 determines that an operation to submit the response data has been received, and the processing proceeds to step S306. If the button 612 is pressed, the processing proceeds to step S305.

In step S305, the CPU 201 determines whether or not the processing in FIG. 3 is to be terminated. If the CPU 201 determines that the processing is to be terminated, it terminates the processing in FIG. 3. On the other hand, if the CPU 201 determines that the processing is not to be terminated, the processing proceeds to step S303. For example, if a cancel button (display item not shown) for canceling the processing of “School Classroom” is operated, it is determined that the processing in FIG. 3 is to be terminated.

In step S306, the CPU 201 performs processing to analyze a response completion degree in the response data obtained in step S303. For example, the CPU 201 causes the communication unit 204 to transmit the response data and an instruction to make a request for analysis of the response completion degree to the condition determination server 102. The CPU 201 then receives the result of analyzing the response completion degree from the condition determination server 102. That is, the CPU 201 performs processing to request the condition determination server 102, which is an external server, to analyze the response completion degree, and obtains the result of the request. Note that the information processing apparatus 101 may alternatively be configured to analyze the response completion degree, rather than requesting an external server to analyze it. The analysis of the completion degree is not scoring itself, but an analysis based on a criterion that is not related to scoring criteria (i.e., not affected by whether the response is correct or incorrect).

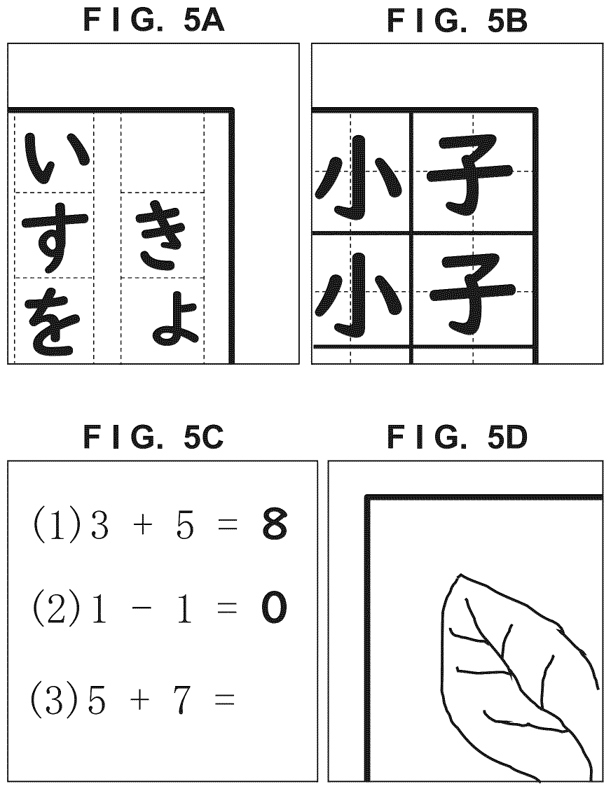

Refer to FIG. 4. FIG. 4 is a flowchart illustrating processing for analyzing the response completion degree in step S306. In the description here, a case in which the condition determination server 102 performs the processing shown in FIG. 4 is taken as an example. Note that the processing shown in FIG. 4 may alternatively be executed, for example, by the information processing apparatus 101 as mentioned above. The processing in FIG. 4 is implemented, for example, by a CPU of each device loading a program stored in a ROM, which is a computer-readable recording medium, to a RAM and executing it.

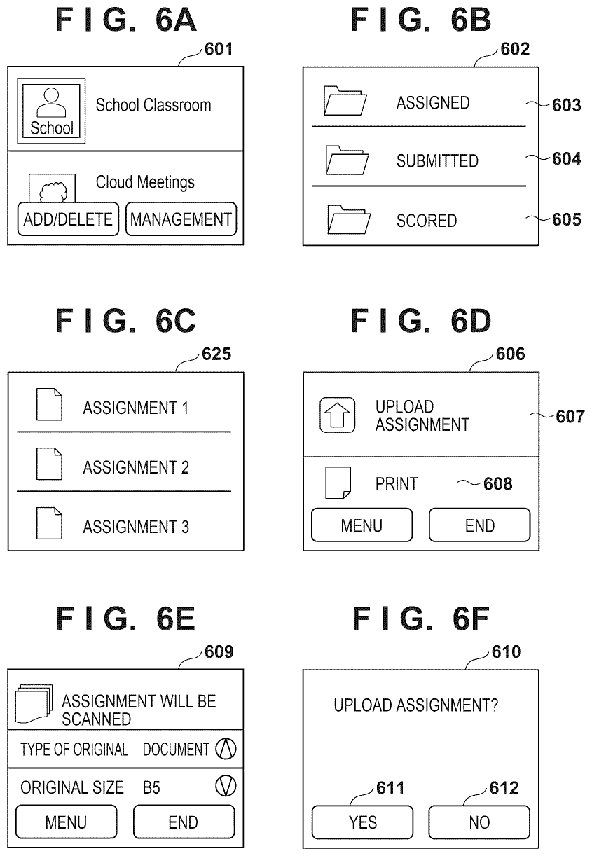

In step S401, upon receiving the response data from the information processing apparatus 101, the condition determination server 102 judge an assignment category of the response data. FIGS. 5A to 5D depict examples of assignment categories. FIG. 5A shows an example of response data when the assignment is a composition. FIG. 5B shows an example of response data when the assignment is to practice characters such as Kanji (Chinese character) and Hiragana. FIG. 5C shows an example of response data when the assignment is a calculation exercise. FIG. 5D shows an example of response data when the assignment is a sketch such as an observation diary. In this manner, the assignment category differs depending on the response data. Thus, this judgment is performed in order to select an analysis method for each assignment category.

In step S402, the condition determination server 102 selects an analysis method based on the assignment category judged in step S401. The analysis method may be, for example, a method of analyzing a response entry rate for the assignment. For example, in the calculation exercise shown in FIG. 5C, only two of the three questions have been answered. As a result of the analysis in this case, the entry rate is 2/3 (67%). Whether or not the answers (“8” and “0”) to the questions are correct is not taken into account.

Further, for example, a method may also be used in which the learner's handwriting is stored in the form of a database in a memory each time an assignment is submitted, and the analysis is performed using the learner's handwriting. For example, a method may also be used in which whether or not the learner has entered a response by themselves based on the learner's handwriting. In this case, a portion that is determined as the learner's handwriting is taken into account in the completion degree of the learner themselves, and other portions are not taken into account in the completion degree of the learner. This ensures that cases in which responses were made by others (so-called spoofed responses) are analyzed as a low completion degree.

Further, a method may also be used in which whether or not a response is carefully written is analyzed based on, for example, irregularities in handwriting. In this case, a portion assumed to be readable by a scorer is taken into account in the completion degree, and a portion that is so disorganized that it is assumed to be unnecessary is not taken into account in to the completion degree. With this, responses entered in a disorganized and unintelligible manner are analyzes as a low completion degree.

For example, for categories such as composition and reports, a method may also be used in which the analysis is performed by comparing comparison target data with response data submitted by the learner. In such a comparison, if the response data is an image containing hand-written entry content, text in the image is recognized and extracted by a technique such as an OCR (Optical Character Reader) and compared with the comparison target text. The comparison target data is, for example, response data for the same assignment that was submitted in the past. Further, the comparison target data may also be, for example, highly similar data uploaded on the Internet. In other words, the comparison target data is response data from those other than the learner themselves. If it is determined that the response data is highly similar to that of another person, it is suspected that the learner has copied answers to past questions. In this case, it is determined, as a result of the analysis, that the learner's completion degree is low.

One of the above analysis methods (analysis criteria) may be used, or the completion degree may be analyzed by combining two or more of the above methods. The analysis methods are not limited to the above. All of the analysis methods are different from an analysis for scoring, and are analyses according to criteria (methods) that are not related to scoring criteria (i.e., not affected by whether the responses are correct or incorrect). Further, the above analysis is different from analyzing whether or not each response was made to an item that is preset as a required response item. That is, the above analysis is analyzing the response completion degree for not only required response items but also a plurality of response items that do not necessarily require responses. Also, even if a response was made to an item preset as a required response item, the content of the response is analyzed to determine whether or not the learner has responded appropriately.

In step S403, the condition determination server 102 measures the response completion degree using the analysis method selected in step S402. In this manner, the condition determination server 102 analyzes the learner's engagement in the assignment without regard to the scoring criteria or the correctness of the responses. Note that, in the case of a calculation question, for example, the completion degree may be measured by also taking into account the writing of strokes outside the frame.

Here, for example, in steps S401 and S403, the condition determination server 102 may perform processing using machine learning or according to an algorithm. When machine learning is used, a learning model is created in advance for each of steps S401 and S403 by using supervised data and response data for each assignment category in a case where the assignment was normally implemented and in other cases.

Return to the description of FIG. 3. In step S307, the CPU 201 determines whether or not the analysis result in step S306 satisfies a predetermined condition. If the CPU 201 determines that the predetermined condition is satisfied, the processing proceeds to step S308. On the other hand, if the CPU 201 determines that the predetermined condition is not satisfied, the processing proceeds to step S310. The case where the predetermined condition is satisfied is, in other words, the case where the analysis result is a “good” evaluation.

The predetermined condition in step S307 is satisfied when the completion degree is moderately good as a result of the analysis in step S306, and is not satisfied when the completion degree is low. That is, the predetermined condition is a condition that is satisfied when a response was appropriately made to the assignment and not satisfied when it is assumed that the response was not appropriately made. Whether the learner has made responses appropriately is important, and the viewpoint of whether the scoring result is good and whether the correct answer rate is high do not matter here. For example, the condition is that the result of measuring the completion degree in step S306 is higher than a predetermined value. Note that the predetermined value may be, for example, a value that varies for each category of the assignment. Further, the predetermined value may be, for example, a different value for each assignment assigned, or a different value for each learner. Further, the predetermined value may be set by, for example, an instructor or a guardian.

In step S308, the CPU 201 transmits the response data and the analysis result to the transmission destination corresponding to the assignment submission destination. The transmission destination is, for example, the response storage server 103 and the assignment management server 104. The response data transmitted to the assignment submission destination is to be scored, and is referenced and scored by the instructor or a scorer different from the instructor. Alternatively, the system may automatically score the response data. The instructor can check the response data and the analysis result transmitted in step S308 from the communication terminal 107, for example, via the response storage server 103 and the assignment management server 104. After the response data and the analysis result are transmitted to the response storage server 103 and the assignment management server 104, they are synchronized with the completion status visualization server 105. Also, in step S308, the CPU 201 transmits the response data and the analysis result in step S306 to the completion status visualization server 105. Also, in step S308, the CPU 201 causes the display unit 208 to display a notification screen 613 shown in FIG. 6G. The notification screen 613 displays a message indicating that the response data for the assignment has been transmitted to the response storage server 103 and the assignment management server 104.

In step S309, the CPU 201 notifies the guardian of the submission of the assignment and the analysis result in step S306. For example, the CPU 201 transmits a notification of the submission of the assignment and the analysis result in step S306 to the communication terminal 106 of the guardian. For example, if the result of the determination in step S307 is “Yes”, the CPU 201 notifies the guardian that the response completion degree is high as the analysis result. Note that this notification may be, for example, in a mode in which the response data and the analysis result are synchronized with the status visualization server 105 and thereby transmitted from the completion status visualization server 105 to the communication terminal 106 of the guardian. Also, for example, the notification may be in a mode that only notifies the guardian that the assignment has been submitted. Each notification is, for example, at least one of e-mail transmission to an e-mail address registered as the guardian's e-mail address, a push notification to application software associated with “School Classroom” installed in the communication terminal 106, and transmission of a short message to a phone number of the communication terminal 106.

In step S310, the CPU 201 notifies the learner, who is the transmission source of the response data, of the analysis result. FIG. 6H shows an example of a notification screen 614 that the CPU 201 causes the display unit 208 to display in step S310. The notification screen 614 displays a message indicating that the response completion degree (point score) is low and a message encouraging the learner to respond to the assignment again. Thus, if the response completion degree is low, displaying these messages can encourage the learner to re-engage in the assignment or correct the response so as to improve the response completion degree. Further, the notification screen 614 may also display, for example, a message encouraging the learner to review the response content. The notification screen 614 also displays a button 616 that enables receiving a non-submission instruction not to submit the response data, a button 617 that enables receiving a submission instruction to submit the response data, and a button 618 that enables receiving a stop instruction to stop submitting the assignment.

Thus, when the response analysis result satisfies the predetermined condition, the CPU 201 transmits the response data and the analysis result to the transmission destination. On the other hand, if the predetermined condition is not satisfied, the CPU 201 causes the notification screen 614 to be displayed and performs control not to transmit the response data and the analysis result to the transmission destination. Such control allows the learner to submit the assignment when the learner has seriously engaged in the assignment. Conversely, response data prepared by the learner who has not seriously engaged in the assignment is prevented from being submitted and scored, so that the scoring load on the scorer can also be reduced.

Note that the notification screen 614 displays the button 617 that enables receiving a submission instruction as mentioned above. In this regard, for example, there is a possibility that the learner has actually engaged seriously in the assignment even if the CPU 201 determines that the predetermined condition is not satisfied. For this reason, it can be said that the CPU 201 performs the control not to accept the submission of the assignment temporarily (suspend acceptance of submission) in order to encourage the learner to re-engage in the assignment, rather than not accepting the submission of the response data at all.

In step S311, the CPU 201 determines whether the submission operation has been performed after the notification screen 614 was displayed. If the CPU 201 determines that the submission operation has been performed, the processing proceeds to step S308. On the other hand, if the CPU 201 determines that the submission operation has not been performed, the processing proceeds to step S312. Specifically, if the button 617 has been pressed, the CPU 201 determines that the submission operation has been performed.

In step S312, the CPU 201 determines whether or not an instruction to execute re-response has been received. If the button 616 has been pressed, the CPU 201 determines that the instruction to execute re-response has been received, and the processing proceeds to step S303. On the other hand, if the CPU 201 determines that the instruction to execute re-response has not been received, the processing proceeds to step S313.

In step S313, the CPU 201 determines whether or not the button 618 has been pressed. If the CPU 201 determines that the button 618 has been pressed, the processing in FIG. 3 ends. On the other hand, if the CPU 201 determines that the button 618 has not been pressed, the processing proceeds to step S311.

Note that in the case of “YES” in step S313, the CPU 201 does not transmit the response data for the assignment to the response storage server 103 and the assignment management server 104. In such a case, even if the learner presses the display item 604 on the assignment management screen 602, the response data subjected to the submission operation in step S304 is not displayed as submitted data on the display unit 208. The response data transmitted to the assignment submission destination in step S308 is stored in a “Submitted” folder, and the response data transmitted in step S308 is displayed on a screen displaying data stored in the “Submitted” folder.

Note that different processing may be performed for the notification to the guardian when the response data is submitted in a state where the analysis result in step S306 satisfies the predetermined condition and for the notification to the guardian when the response data is submitted in a state where the analysis result in step S306 does not satisfy the predetermined condition. The notification to the guardians when the response data is submitted in a state where the analysis result in step S306 satisfies the predetermined condition is the processing in step S309 in the case of “Yes” in step S307. Hereinafter, the notification in this case is referred to as a notification in the case of a “good” evaluation. The notification to the guardian when the response data is submitted in a state where the analysis result in step S306 does not satisfy the predetermined condition is the processing in step S309 in the case of “No” in step S307 and “Yes” in step S311. Hereinafter, the notification in this case is referred to as a notification in the case of a “poor” evaluation. A configuration may be employed in which the guardian is not notified of the analysis result in step S306 (information indicating the completion degree) in the notification in the case of a “good” evaluation, and the guardian is notified of the analysis result in step S306 (information indicating the completion degree) in the notification in the case of a “poor” evaluation. Further, a configuration may be employed in which the guardian is not notified whether or not the determination result was a “good” evaluation in the notification in the case of a “good” evaluation, and the guardian is notified that the determination result was a “poor” evaluation in the notification in the case of a “poor” evaluation. Further, in the notification in the case of a “good” evaluation, a message may be given to the guardian to encourage involvement to praise or approve of the learner's efforts to learn. For example, a message is given, such as “Your child is appropriately engaged in the assignment. Please praise him/her for his/her attitude toward the engagement.”. In the notification in the case of a “poor” evaluation, a message may be given to the guardian to encourage involvement in the learner's engagement in the assignment. For example, a message is given, such as “Your child may have not responded appropriately. Please encourage him/her to work hard on assignments for the subject he/she is not good at too”. Also, a message may be given, such as “Your child may have not responded appropriately. Please engage with the assignment together with him/her”.

As described above, according to the present embodiment, the information processing apparatus 101 obtains response data for the assignment in step S303. The information processing apparatus 101 perform processing in step S306 to analyze the response completion degree in the obtained response data without regard to the scoring criteria or the correctness. If the analysis result satisfies the predetermined condition, in step S308, the information processing apparatus 101 transmits the response data to the transmission destination corresponding to the assignment submission destination, based on the button 611 being pressed. On the other hand, if the analysis result does not satisfy the predetermined condition, in step S310, the information processing apparatus 101 displays the notification screen 614 based on the button 611 being pressed. That is, if the analysis result does not satisfy the predetermined condition, the information processing apparatus 101 performs control so as not to transmit the response data to the transmission destination. Thus, in this embodiment, the control is performed such that the assignment is not submitted if the response completion degree is low. This control allows the learner to seriously engage in the assignment and submit the assignment.

Note that, in this embodiment, the processing proceeds to step S308 if the CPU 201 determines in step S311 that the submission operation has been performed. However, there is no limitation thereto. For example, if, in step S311, the CPU 201 determines that the submission operation has been performed, the CPU 201 may cause the display unit 208 to display a notification screen 619 in FIG. 6I. The notification screen 619 displays, for example, a notification section 620. The notification section 620 shows a message indicating that the analysis result will be transmitted to the communication terminal 106 of the guardian, who is the transmission destination, to the learner, who is the transmission source of the response data. Also, the notification section 620 shows a message asking the learner about whether or not to transmit the response data. The notification screen 619 also displays a button 621 that enables receiving a submission instruction to submit the response data, and a button 622 that enables receiving a non-submission instruction not to submit the response data. The CPU 201 may be configured such that the processing proceeds to step S308 if the button 621 is pressed, and the processing proceeds to step S303 if the button 622 is pressed. For example, even if the notification screen 614 is displayed in step S310, the learner may attempt to submit the assignment as it is. Thus, a mode of further warning the learner that the analysis result will be transmitted to the guardian via the notification screen 619 may also be employed. This can encourage the learner to, for example, re-engage in the assignment when the learner has engaged in the assignment not seriously and is about to submit the assignment.

In the above description of the present embodiment, in step S312, the processing proceeds to step S303 if the CPU 201 determines that an instruction to execute re-response has been received. That is, as a result of the CPU 201 causing the notification screen 614 to be displayed, there is a possibility that the learner re-engages in the assignment and performs the assignment submission operation. In such a case, a mode of notifying the guardian and the instructor that the learner has re-engaged in the assignment may also be employed. Further, the learner may also be notified that such notification has been given to the guardian and the instructor.

Specifically, for example, in step S308, the CPU 201 may reference the RAM 203 and obtain information indicating that the learner has re-engaged in the assignment. The CPU 201 may then transmit the information indicating that the learner has re-engaged in the assignment, together with the response data and the analysis result, to the transmission destination corresponding to the assignment submission destination. By thus transmitting the information indicating that the learner has re-engaged in the assignment to the response storage server 103 and the assignment management server 104, the instructor can grasp that the learner has seriously re-engaged in the assignment. The information indicating that the learner has re-engaged in the assignment is stored in the RAM 203, for example, in step S312 when the CPU 201 determines that an instruction to execute re-response and the processing proceeds to step S303. Also, in step S309, the CPU 201 may notify the guardian of the information indicating that the learner has re-engaged in the assignment, together with the response data and the analysis result. By thus notifying the guardian, the guardian can grasp that the learner have seriously engaged in the assignment.

If the response data is transmitted in a state where the information indicating that the learner re-engaged in the assignment has been recorded (i.e., if the processing in step S308 is performed after the determination result in step S312 is “YES”), the CPU 201 may cause the display unit 208 to display a notification screen 623 in FIG. 6J. The notification screen 623 displays a message indicating that the instructor and the guardian have been notified that the learner re-engaged in the assignment. For example, a message: “Your teacher and guardian have been notified of your effort!” is displayed. “Your effort” is an example of a positive message that contains a meaning of praise and encouragement for the learner's effort to have re-engaged in the assignment. By indicating that the instructor and guardian have been notified of such positive content, the learner can recognize the possibility that the instructor and guardian will be positively aware of the effort to engage in the assignment. That is, the notification screen 623 contributes to satisfaction of the learners' esteem needs. The learner who has had this experience will be motivated to appropriately and seriously engage in the assignment when engaging in the next assignment. In this way, the notification screen 623 can promote the learner to seriously engage in the assignment and submit the assignment. The notification screen 623 may also display a message praising and encouraging the learner, such as “You did a great job!”.

### Second Embodiment

The second embodiment is described below regarding differences from the first embodiment. In the first embodiment, a printing apparatus has been described as an example of the information processing apparatus 101. The information processing apparatus 101 obtains response data by causing the image capture unit 209 to scan a fill-in form. The description of the present embodiment takes as an example a case where a communication terminal such as a smartphone or a tablet terminal is used as the information processing apparatus 101.

### Hardware Configuration of Information Processing Apparatus

In the present embodiment, the information processing apparatus 101 includes, for example, a CPU 201, a ROM 202, a RAM 203, and a communication unit 204. These components are the same as those illustrated in FIG. 2, for example, and the description thereof is omitted. In the present embodiment, the image capture unit 209 is a camera. Further, in the present embodiment, the information processing apparatus 101 includes an operation unit 207 and a display unit 208, which are integrated as an operation display unit constituted by a touchscreen display.

### Assignment Submission Processing

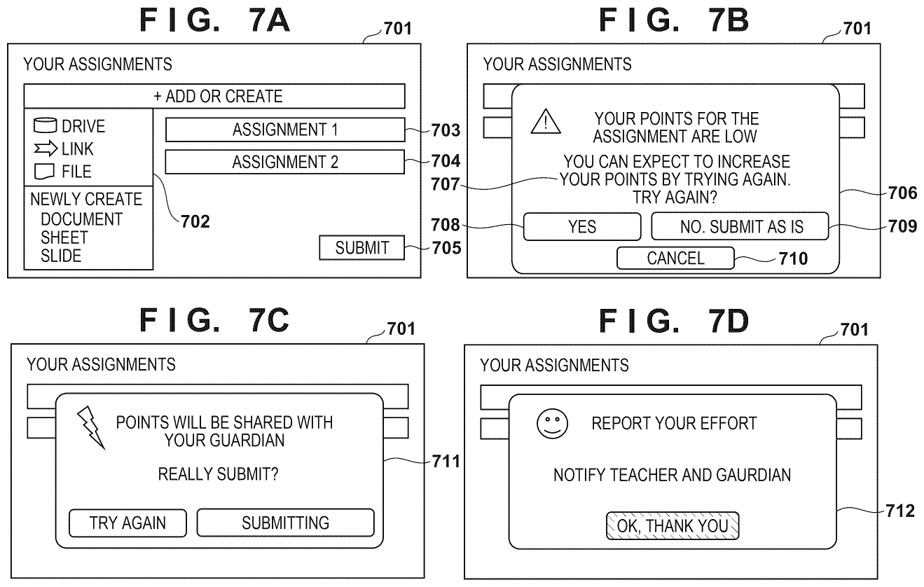

Processing in FIG. 3 according to the present embodiment is described. In step S301, the CPU 201 causes the display unit 208 to display, for example, an operation screen 701 shown in FIG. 7A, and receives an instruction to select an assignment to be submitted. For example, the operation screen 701 displays a dialog 702 for obtaining assignment data. If “drive”, which is a display item included in the dialog 702, is operated, the CPU 201 obtains data on the assignment assigned to the learner by the instructor from the assignment management server 104, and causes display items 703 and 704, each of which enables receiving an instruction to select the assignment, to be displayed on the operation screen 701. Also, for example, if “file”, which is a display item included in the dialog 702, is operated, the CPU 201 obtains data on the assignment stored in a storage medium that can be accessed by the information processing apparatus 101, such as the ROM 202, and causes the display items 703 and 704, each of which enables receiving an instruction to select the assignment, to be displayed on the operation screen 701. The operation screen 701 also displays a display item 705 that enables receiving an instruction to upload response data for the assignment to be submitted (i.e., to transmit the response data to the assignment submission destination).

In step S302, when receiving an instruction to select an assignment given by selecting either the display item 703 or 704 on the operation screen 701, the CPU 201 causes the display unit 208 to display a response input screen (not shown).

In step S303, the CPU 201 obtains response data. In the present embodiment, the CPU 201 obtains the response data by causing the image capture unit 209, which is a camera, to capture an image of a fill-in form in which responses have been entered. Note that the CPU 201 is not limited to obtaining the response data using the image capture unit 209. For example, the CPU 201 may cause the display unit 208 to display a response input screen for the assignment and obtain, as response data, the content input based on a user operation on the display unit 208. In other words, the CPU 201 may also receive input of responses to the display unit 208, which is a touch screen or the like.

In step S304, the CPU 201 determines whether or not an operation to submit the response data has been received. If the display item 705 has been pressed, the CPU 201 determines that the submission operation has been received, and the processing proceeds to step S306. On the other hand, if the CPU 201 determines that a submission operation has not been received, the processing proceeds to step S305.

Processing in steps S305 to S309 is the same as the first embodiment, and the description thereof is omitted accordingly.

In step S310, the CPU 201 notifies the learner, who is the transmission source of the response data, of the analysis result. FIG. 7B shows an example of an analysis result notification according to the present embodiment. In the present embodiment, the CPU 201 causes a dialog 706 to be displayed on the operation screen 701. The dialog 706 displays a message indicating that the response completion degree (point score) is low and a message prompting the learner to resubmit the assignment. Also, the dialog 706 displays a message that the completion degree may increase by re-engaging in the assignment. Such a message can be expected to motivate the learner when re-engaging in the assignment. The dialog 706 also displays a button 709 that enables receiving a submission instruction to submit response data (corresponding to the button 617 in the first embodiment), and a button 708 that enables receiving a non-submission instruction not to submit the response data (corresponding to the button 616 in the first embodiment). The dialog 706 may also display a button 710 that enables receiving a stop instruction to stop submission of the assignment (corresponding to the button 618 in the first embodiment).

Processing in steps S311 to S313 is performed in the same manner as in the first embodiment, and the description thereof is omitted accordingly.

So far, in the present embodiment, an example has been described in which a communication terminal such as a smartphone or a tablet terminal is used as the information processing apparatus 101. In the present embodiment, when the processing shown in FIG. 3 is performed, response data is obtained by capturing an image of responses using the image capture unit 209 (camera). Thus, even if the information processing apparatus 101 does not have a scanning function, it can perform the assignment submission processing shown in FIG. 3 by using a camera or the like.

In this embodiment, if the CPU 201 determines in step S311 that the submission operation has been performed (i.e., if the button 709 has been operated), the CPU 201 may cause the display unit 208 to display a dialog 711 shown in FIG. 7C, similar to the first embodiment. The dialog 711 is an example of notification corresponding to the notification screen 619 in the first embodiment.

As a result of the CPU 201 causing the dialog 706 to be displayed, there are cases where the learner re-engages in the assignment and perform the assignment submission operation. In such a case, similar to the first embodiment, a mode of notifying the guardian and the instructor that the learner has re-engaged in the assignment may also be employed. Also, a message may be indicated that the instructor and the guardian have been notified of the learner's effort. For example, if the learner re-engages in the assignment and performs the assignment submission operation, the CPU 201 may cause the display unit 208 to display the dialog 712. The dialog 711 is an example of notification corresponding to the notification screen 623 in the first embodiment.

### Other Embodiments

Note that the various controls described above as controls performed by the CPU 201 may be performed by one piece of hardware, or a plurality of pieces of hardware (e.g., a plurality of processors and circuits) may share the processing to control the entire apparatus.

Also, while the present disclosure has been described in detail based on the preferred embodiments thereof, the disclosure is not limited to these particular embodiments, and various modes within the scope that do not depart from the gist of the disclosure are also included in the disclosure. Furthermore, each of the above-described embodiments only illustrate one embodiment of the present disclosure, and it is also possible to combine the embodiments as appropriate.

Although the above embodiments have been described with reference to an example in which the present disclosure is applied to a printing device, a smartphone, and a tablet terminal serving as an information processing apparatus, there is no limitation to this example. The present disclosure can be applied to any of an image capture device having an image capture function, a display control device having an input function that enables input to a screen or the like, and an electronic device having at least one of the image capture function and the input function. The present disclosure can be applied to, for example, a personal computer, a PDA, a mobile phone terminal, a portable image viewer, a printing device with a display, a digital photo frame, a music player, a game machine, an electronic book reader, and the like. Also, the present disclosure can also be applied to an electronic white board, an electronic notebook, a touch screen table, smart glasses, a head-mounted display device, and the like.

The present disclosure is also implemented by executing the following processing. That is, the present disclosure can also be implemented by executing processing in which software (program) that implements one or more functions of the above-described embodiments is supplied to a system or a device via a network or any of various storage media, and a computer (or a CPU, an MPU etc.) of the system or the device reads and executes program code. In this case, the program and the storage medium storing the program constitute the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-117236, filed Jul. 22, 2024, which is hereby incorporated by reference herein in its entirety.

What is claimed is:

1. An information processing apparatus, comprising
at least one memory and at least one processor which function as:
an obtaining unit configured to obtain response data for an assignment to be scored;
a processing unit configured to perform processing to analyze a response completion degree in the response data obtained by the obtaining unit, without regard to a criterion for scoring; and
a control unit configured to perform control to:
in a case where a result of the analysis satisfies a predetermined condition, transmit the response data to a first transmission destination corresponding to an assignment submission destination based on a first operation for submitting the assignment; and
in a case where the result of the analysis does not satisfy the predetermined condition, not transmit the response data to the first transmission destination based on the first operation.

2. The information processing apparatus according to claim 1,
wherein the response data that has been transmitted to the first transmission destination is to be scored, and
the response data that has not been transmitted to the first transmission destination is not to be scored.

3. The information processing apparatus according to claim 1,
wherein the analysis includes an analysis different from an analysis of whether or not a response has been made to an item that is preset as a required response item.

4. The information processing apparatus according to claim 1,
wherein the at least one memory and the at least one processor further function as:
a first notification unit configured to, in a case where the result of the analysis does not satisfy the predetermined condition, give a notification of the result of the analysis to a transmission source of the response data.

5. The information processing apparatus according to claim 4, wherein the notification indicates that the completion degree is low.

6. The information processing apparatus according to claim 4, wherein the notification includes a message promoting re-response to the assignment.

7. The information processing apparatus according to claim 1,
wherein in a case where the result of the analysis does not satisfy the predetermined condition, the control unit performs control to transmit the result of the analysis to a second transmission destination different from the first transmission destination.

8. The information processing apparatus according to claim 7,
wherein the at least one memory and the at least one processor further function as:
a second notification unit configured to, in a case where the result of the analysis does not satisfy the predetermined condition, notify a transmission source of the response data that the result of the analysis is transmitted to the second transmission destination.

9. The information processing apparatus according to claim 8,
wherein the second transmission destination is a communication terminal owned by a guardian of a learner that is the transmission source.

10. The information processing apparatus according to claim 1,
wherein in a case where the result of the analysis does not satisfy the predetermined condition, the control unit performs control to transmit the response data to the first transmission destination based on a second operation different from the first operation.

11. The information processing apparatus according to claim 10,
wherein when the response data is transmitted based on the second operation, the response data and information indicating that the second operation has been performed are transmitted to the first transmission destination.

12. The information processing apparatus according to claim 1, further comprising:
an image sensor configured to capture an image of a fill-in form for a response to the assignment,
wherein the obtaining unit obtains captured image data of the fill-in form as the response data.

13. The information processing apparatus according to claim 1, wherein the analysis includes processing using a learning model of machine learning.

14. The information processing apparatus according to claim 1,
wherein the analysis includes an analysis of whether the response data is similar to comparison target data.

15. The information processing apparatus according to claim 1,
wherein the processing unit requests an external server to perform the analysis, and performs processing to obtain the result of the analysis from the external server.

16. The information processing apparatus according to claim 1,
wherein the at least one memory and the at least one processor further function as:
a display control unit configured to perform control to display the response data transmitted to the first transmission destination as submitted data.

17. The information processing apparatus according to claim 1, wherein the information processing apparatus is a printing apparatus having a printer.

18. The information processing apparatus according to claim 1, wherein the completion degree is an entry rate at which the response is entered.

19. A control method for an information processing apparatus, the method comprising:
obtaining response data for an assignment to be scored;
performing processing to analyze a response completion degree in the obtained response data, without regard to a criterion for scoring; and
performing control to:
in a case where a result of the analysis satisfies a predetermined condition, transmit the response data to a first transmission destination corresponding to an assignment submission destination based on a first operation for submitting the assignment; and
in a case where the result of the analysis does not satisfy the predetermined condition, not transmit the response data to the first transmission destination based on the first operation.

20. A non-transitory computer-readable storage medium storing a program configured to cause a computer as:
an obtaining unit configured to obtain response data for an assignment to be scored;
a processing unit configured to perform processing to analyze a response completion degree in the response data obtained by the obtaining unit, without regard to a criterion for scoring; and
a control unit configured to perform control to:
in a case where a result of the analysis satisfies a predetermined condition, transmit the response data to a first transmission destination corresponding to an assignment submission destination based on a first operation for submitting the assignment; and
in a case where the result of the analysis does not satisfy the predetermined condition, not transmit the response data to the first transmission destination based on the first operation.
